(19) United States
(12) Patent Application Publication
(10) Pub. No.: US 2021/0373728 A1
(43) Pub. Date: Dec. 2, 2021

(54) MACHINE LEARNING-ASSISTED GRAPHICAL USER INTERFACE FOR CONTENT ORGANIZATION

(71) Applicant: Microsoft Technology Licensing, LLC, Redmond, WA (US)

(72) Inventors: Justin James Wagle, Pacifica, CA (US); Nathaniel G. Roth, San Bruno, CA (US); Alekhya Nandula, Oakland, CA (US); Amy Wu, San Francisco, CA (US); Dustin D. Brown, Sacramento, CA (US); Peter T. Martin, Mill Value, CA (US); Elmar H. Langholz Villareal, San Francisco, CA (US)

(21) Appl. No.: 16/886,511

(22) Filed: May 28, 2020

(51) Int. Cl. G06F 3/0484; H04L 29/08

(52) U.S. Cl. CPC G06F 3/0484; H04L 67/02

(57) ABSTRACT

Embodiments described herein are directed to a graphical user interface (GUI) for efficiently managing and organizing data items. The GUI utilizes machine learning-based clustering techniques that cluster data items into different clusters. The GUI displays each cluster as a user-selectable UI element. Each UI element displays keywords that are representative of the associated data items. The GUI enables the user to merge clusters together by interacting with the UI elements. For instance, the user may drag and drop one UI element over another UI element to combine the associated clusters. The GUI also enables a user to selectively associate certain Web pages of one cluster with another cluster. For instance, the GUI enables the user to move a keyword from one UI element to another UI element. The data items associated with that keyword are moved to the cluster represented by the other UI element.

### BACKGROUND

At any given time, a user's computing device may comprise thousands of files. Searching through the files for specific content can be a tedious task. When a user uses a file viewer application to view such files, they are bombarded with a rather long list without immediately having any context as to how any of the files are related. File viewer applications attempt to organize such information. However, such applications are limited to organizing files by the basic metadata properties provided by the file system itself (e.g., by name, dates, size, etc.). Thus, the user is forced to go through each and every file individually, determine the relevance of the file, and manually organize such files accordingly.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and apparatuses are directed to a graphical user interface for efficiently managing and organizing data items, such as Web pages of a user's browsing history. The graphical user interface utilizes machine learning-based clustering techniques that cluster data items into different clusters. The graphical user interface displays each of the clusters as a user-selectable user interface element. Each user-selectable user interface element may display keywords that are representative of the data items associated therewith. The graphical user interface enables the user to merge clusters together by interacting with the user-selectable user interface elements. For instance, the user may drag and drop one user-selectable user interface element over another user-selectable user interface element to combine the associated clusters. The graphical user interface also enables a user to selectively associate certain Web pages of one cluster with another cluster. For instance, the graphical user interface enables the user to move a keyword from one user-selectable user interface element to another user-selectable user interface element. The data items associated with that keyword are moved to the cluster represented by the other user-selectable user interface element.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system configured to provide a user interface that enables a user to manage and organize data items in accordance with an example embodiment.

FIG. 2 is a block diagram of a system configured to provide a user interface that enables a user to manage and organize a user's browser history in accordance with an example embodiment.

FIG. 3 is a block diagram of a clusterizer configured to cluster Web pages into different clusters in accordance with an example embodiment.

FIGS. 4A-4B depict example graphical user interface (GUI) screens that enable a user to merge two clusters together in accordance with example embodiments.

FIGS. 4C-4D depict example GUI screens that enable a user to selectively associate certain Web pages of one cluster with another cluster in accordance with example embodiments.

FIG. 5 depicts a flowchart of an example method for managing and organizing a user's browser history in accordance with an example embodiment.

FIG. 6 depicts a flowchart of an example method for selectively moving data items from one cluster to another cluster in accordance with an example embodiment.

FIG. 7 is a block diagram of an exemplary user device in which embodiments may be implemented.

FIG. 8 is a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Embodiments described herein are directed to a graphical user interface for efficiently managing and organizing data items, such as Web pages of a user's browsing history. The graphical user interface utilizes machine learning-based clustering techniques that cluster data items into different clusters. The graphical user interface displays each of the clusters as a user-selectable user interface element. Each user-selectable user interface element may display keywords that are representative of the data items associated therewith. The graphical user interface enables the user to merge clusters together by interacting with the user-selectable user interface elements. For instance, the user may drag and drop one user-selectable user interface element over another user-selectable user interface element to combine the associated clusters. The graphical user interface also enables a user to selectively associate certain Web pages of one cluster with another cluster. For instance, the graphical user interface enables the user to move a keyword from one user-selectable user interface element to another user-selectable user interface element. The data items associated with that keyword are moved to the cluster represented by the other user-selectable user interface element.

Such techniques advantageously provide an improved user interface that enables a user to efficiently reorganize a plurality of data items via a single operation (e.g., dragging a single user-selectable user interface element representative of a cluster comprising a plurality of data items and dropping that user-selectable user interface element over another user-selectable user interface element). Moreover, such techniques advantageously declutter a user interface, as data items are represented by a relatively smaller number of clusters, rather than being displayed as a long, unorganized list.

In addition, the techniques described herein ensure data privacy. Users are growing increasingly apprehensive of providing their data to third parties, such as technology companies. Users are unsure of how these third parties use their data and whether their data is being sold to other entities. Moreover, the user also has to worry about the security of company servers, as malicious entities are constantly finding new ways to breach corporate security. To remedy this, the techniques described here, including the machine-learning clustering techniques, are performed locally at the end user's computing device, thereby protecting the privacy of the user's data.

Not only is the user's data protected by performing the techniques described herein locally, but the user interface is more responsive, as the user's device is not required to send data to third party servers, e.g., running in a cloud computing environment, for remote machine learning processing and wait for results to be utilized locally at the user's device.

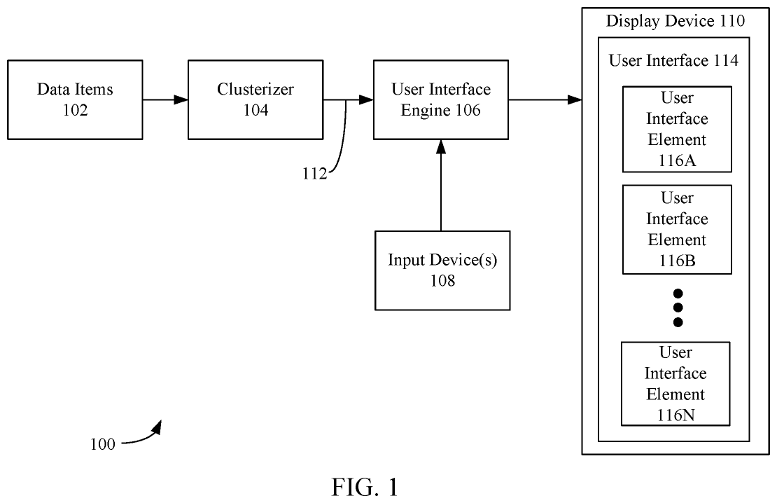

FIG. 1 is a block diagram of a system 100 configured to provide a user interface that enables a user to manage and organize data items in accordance with an example embodiment. As shown in FIG. 1, system 100 includes data items 102, a clusterizer 104, a user interface engine 106, one or more input device(s) 108, and a display device 110. Examples of data items 102 include, but are not limited, image files, documents, Web pages, etc. In accordance with an embodiment, data items 102, clusterizer 104, user interface engine 106, input device(s) 108, and display device 110 are incorporated in a single computing device. In accordance with another embodiment, one or more of data items 102, clusterizer 104, user interface engine 106, input device(s) 108, and display device 110 are distributed across one or more computing devices that are communicatively coupled, for example, via a network. The network may comprise one or more networks such as local area networks (LANs), wide area networks (WANs), enterprise networks, the Internet, etc., and may include one or more of wired and/or wireless portions.

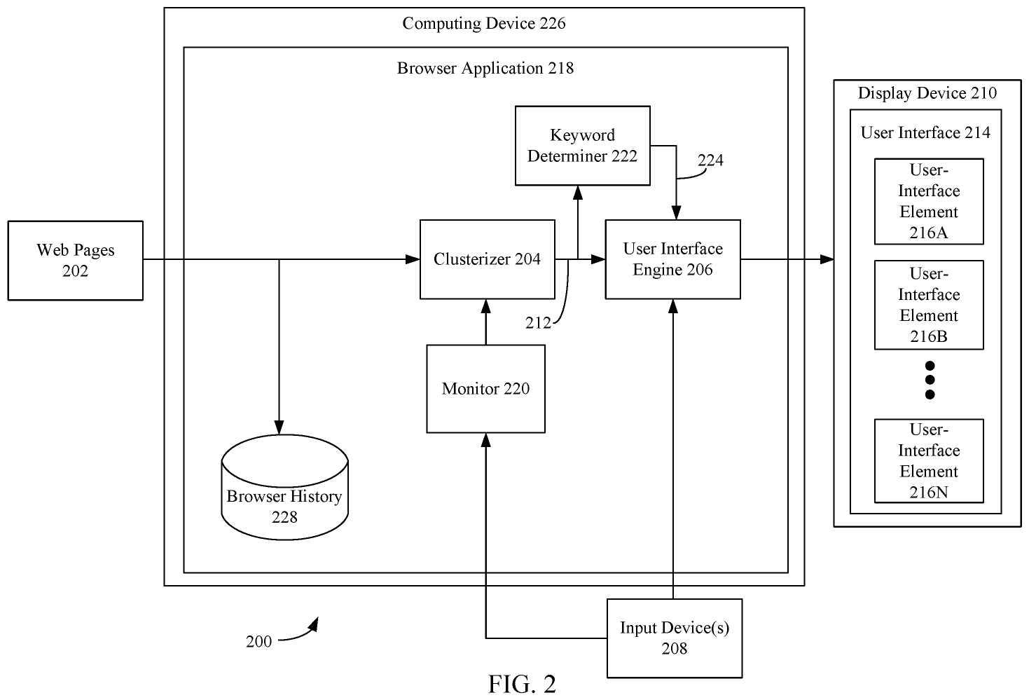

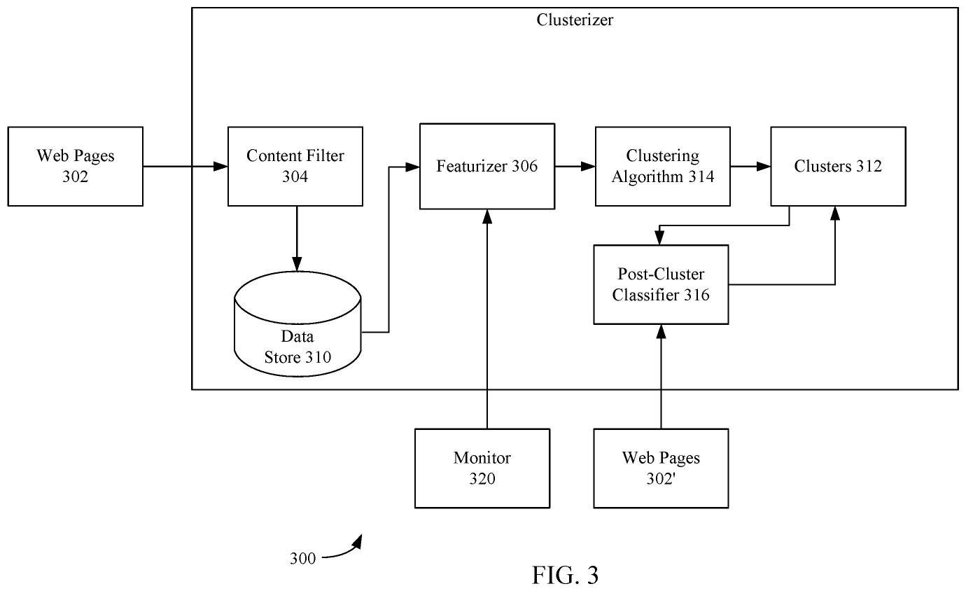

Clusterizer 104 is configured to receive data items 102 as an input and cluster (or group) data items 102 into different clusters 112 based on a degree of similarity. For example, clusterizer 104 may analyze the content of each of data items 102, compare the content to other data items of data items 102, and determine a similarity score with respect to each of data items 102. Data items 102 having similarity scores within a particular threshold are clustered into a respective cluster 112. As will be described below with reference to FIGS. 2 and 3, clusterizer 104 may utilize various machine learning-based algorithms to determine clusters 112.

User interface engine 106 is configured to render each of clusters 112 via a user interface 114 displayed on display device 110. Each of clusters 112 is rendered as a user-selectable user element (e.g., user-selectable user interface elements 116A-116N). User interface engine 106 and/or user interface 114 may be included as part of an operating system or a software application, although the embodiments described herein are not so limited. Examples of software applications include, but are not limited to image viewing applications, browser applications, word processing applications, etc.

Each of user-selectable user interface elements 116A-116N may display a title and/or one or more keywords that are indicative of the subject matter of the data items of data items 102 associated therewith. A user is enabled to manipulate the data items associated with each of clusters 112 by interacting with user-selectable user interface elements 116A-116N. For example, a user is enabled to provide user input (e.g., input device(s) 108) that merges two clusters together. For instance, to merge two clusters together, a user may select a first user-selectable user interface element of user-selectable user interface elements 116A-116N and move the first user-selectable user interface element to a second user-selectable user interface element of user-selectable user interface elements 116A-116N (e.g., the user may perform a drag-and-drop operation). The newly merged clusters are represented by a single user interface element. The merge operation results in the data items associated with the clusters represented by each of the first user-selectable user interface element and the second user-selectable user interface element to be associated with the new, single cluster represented by the single user-selectable user interface element. Both the keywords of the first and second user-selectable user interface elements may be displayed in the single user-selectable user interface element.

In another example, each of the keywords displayed via a particular user-selectable user interface element of user-selectable user interface elements 116A-116N may be selected and moved to another user-selectable user interface element. The data items of data items 102 associated with the selected keyword are then moved to (i.e., associated with) the cluster represented by the other user-selectable user interface element to which the keyword was moved. The moved keyword is also displayed by the other user-selectable user interface element and removed from the user-selectable user interface element from which the keyword was moved.

Examples of input device(s) 108 include, but are not limited to, a mouse, a physical keyboard, a mouse. Input device(s) 108 may also comprise a touch screen. In such an example, input device(s) 108 may be incorporated as part of display device 110.

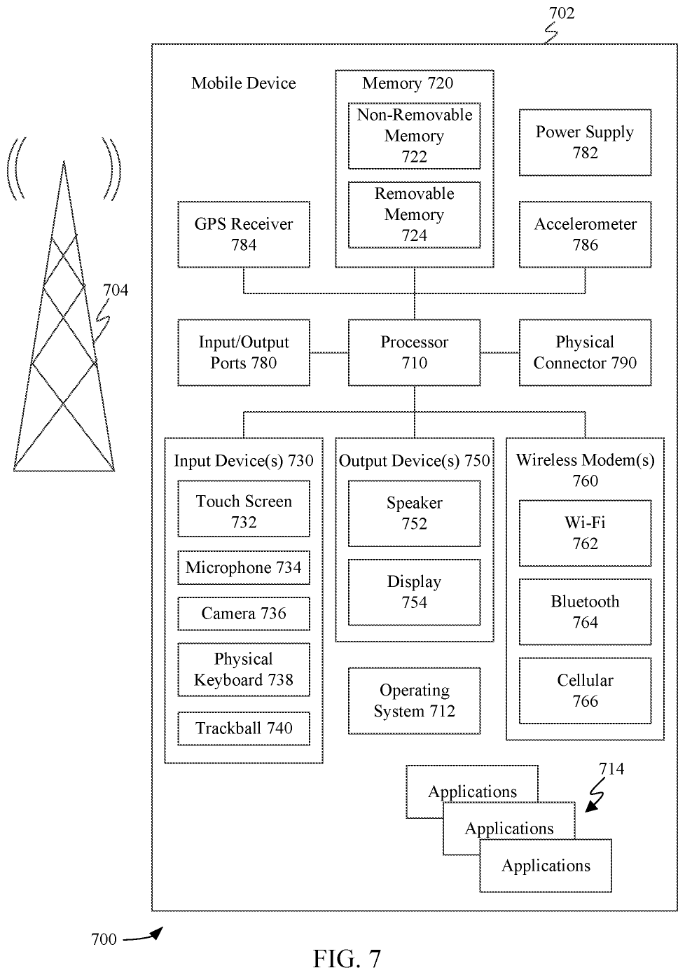

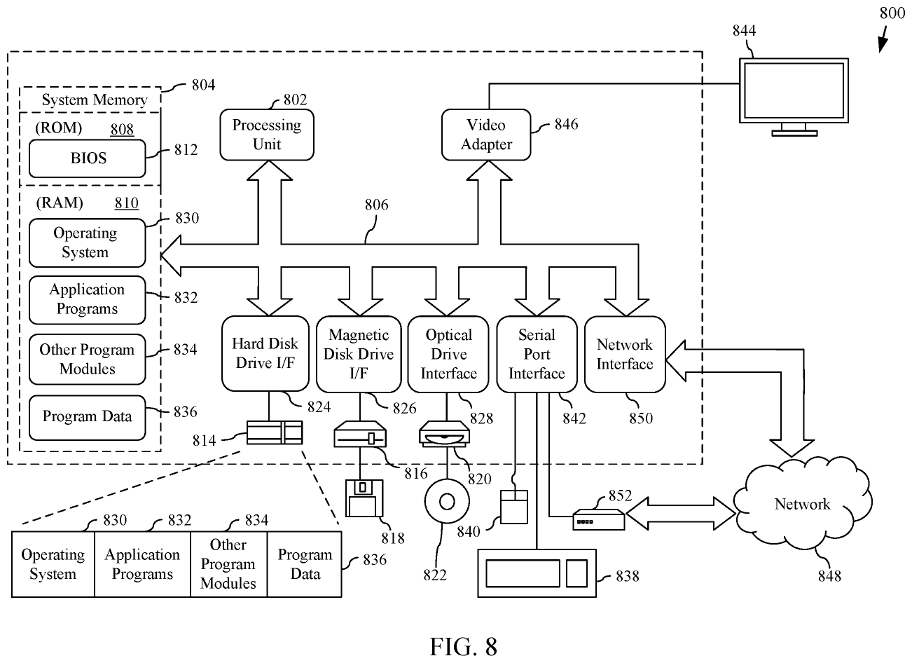

Such techniques may be utilized to cluster any type of data item into different clusters, and such clusters may be manipulated via an operating system (e.g., a file manager of an operating system) and/or various software applications. For example, FIG. 2 is a block diagram of a system 200 configured to provide a user interface that enables a user to manage and organize a user's browser history in accordance with an example embodiment. As shown in FIG. 2, system 200 comprises a computing device 226, input device(s) 208, and a display device 210. Input device(s) 208 and display device 210 are examples of input device(s) 108 and display device 110, as described above with reference to FIG. 1. While input device(s) 208 and display device 210 are depicted as being external to computing device 226, input device(s) 208 and display device 210 may be incorporated as part of computing device 226 in certain embodiments. Computing device 226 may comprise, for example and without limitation, any end-user computing, such as desktop computer, a laptop computer, a tablet computer, a netbook, a smartphone, or the like. Additional examples of computing device 226 are described below with reference to FIGS. 7 and 8.

Computing device 226 is configured to execute a browser application 218. Browser application 218 (i.e. a Web browser) is configured to access Web pages 202 and retrieve and/or present content located thereon via a user interface 214. Browser application 218 stores a listing of Web pages 202 that are traversed during Web browsing sessions in a browser history 228 maintained by browser application 218. Web pages 202 are an example of data items 102, as described above with reference to FIG. 1. Examples of browser application 218 include Microsoft Edge®, published by Microsoft Corp. of Redmond, Wash., Mozilla Firefox®, published by Mozilla Corp. of Mountain View, Calif., Safari®, published by Apple Inc. of Cupertino, Calif., and Google® Chrome, published by Google Inc. of Mountain View, Calif.

As also shown in FIG. 2, browser application 218 comprises a clusterizer 204, a user interface engine 206, a monitor 220, and a keyword determiner 222. Clusterizer 204 and user interface engine 206 are examples of clusterizer 104 and user interface engine 106, as described above with reference to FIG. 1. Clusterizer 204 is configured to cluster (or group) Web pages 202 into different clusters 212 based on a degree of similarity. For example, clusterizer 204 may analyze the content of each of Web pages 202, compare the content to other Web pages of Web page 202, and determine a similarity score with respect to each of Web page 202. Web page 202 having similarity scores within a particular threshold are clustered into a respective cluster 212.

Clusterizer 204 may also determine clusters 216 based on user interactions with respect to Web pages 202. For instance, monitor 220 may monitor such user interactions and provide indications of such interactions to clusterizer 204. Examples of user interactions include, but are not limited, highlighting of text displayed in a particular Web page, the copying and/or pasting of text displayed in a particular Web page, the switching between particular browser application 218 tabs in which Web pages are displayed, etc. Such interactions may be indicative of a particular topic in which the user is interested. Clusterizer 204 may determine clusters 112 based on such interactions. As will be described below with reference to FIG. 3, clusterizer 202 may utilize various machine learning-based algorithms to determine clusters 212.

For example, FIG. 3 is a block diagram of a clusterizer 300 configured to cluster Web pages 302 into different clusters in accordance with an example embodiment. Web pages 302 are examples of Web pages 202, as described above with FIG. 2. As shown in FIG. 3, clusterizer 300 comprises a content filter 304, a featurizer 306, a clustering algorithm 314, a post-cluster classifier 316, and a data store 310. Clusterizer 300 is described in further detail as follows.

As a user views a Web page of Web pages 302, content filter 304 is configured to filter out one or more irrelevant features from Web pages 302. For example, content filter 304 analyzes the Hypertext Markup Language (HTML) of the Web page to determine the irrelevant features. Such feature(s) include, but are not limited to, boilerplate language, advertisements, legal disclaimers, script tags, etc. In accordance with an embodiment, content filter 304 may utilize a supervised machine learning algorithm to analyze the content of Web pages 302 to determine the features that are to be extracted. An example of a supervised machine learning algorithm utilized to filter features from Web pages 302 includes, but is not limited to, a Naive Bayes-based supervised machine learning algorithm. The remaining content of the Web page (i.e., the content not filtered out) is stored in data store 310. Data store 310 may be any type of physical memory and/or storage device (or portion thereof) that is described herein, and/or as would be understood by a person of skill in the relevant art(s) having the benefit of this disclosure.

Featurizer 306 is configured to featurize the filtered content of each of Web pages 302 stored in data store 310. For example, featurizer 306 may be configured to generate a feature vector for the filtered content. As an illustrative example, featurizer 306 may take the filtered content, as an input, and perform a featurization operation to generate a representative output value(s)/term(s) associated with the type of featurization performed, where this output may be an element(s)/dimension(s) of a feature vector. In accordance with an embodiment, featurizer 306 utilizes a frequency—inverse document frequency (TF-IDF) algorithm to featurize the filtered content. For instance, for each filtered Web page 302 stored in data store 310, featurizer 306 may determine the term frequency of each word in the filtered Web page 302, and the inverse document frequency of the word across all of filtered Web pages 302. The term frequency and the inverse document frequency are multiplied together to determine a TF-IDF score, where higher the score, the more relevant or important that word is for that particular Web page. The TF-IDF score for each word for a Web page is stored as a vector of TF-IDF scores.

TF-IDF scores may be further weighted based on user interactions with respect to Web pages 302, as monitored by monitor 320. For example, text that has been interacted with by a user (e.g., via highlighting, copying-and-pasting, etc.) may be given a higher weight than text that has not been interacted with. Similarly, Web pages that have been frequently interacted with by the user (e.g., via tab switching, frequency of visitation, time spent browsing the Web page, etc.), may be given a higher weight than other Web pages. The determined TF-IDF vectors corresponding to Web page 302 are provided to clustering algorithm 314.

Clustering algorithm 314 is configured to cluster the TF-IDF vectors based on a degree of similarity of the terms represented thereby to determine clusters 312, which are examples of clusters 212, as described above with reference to FIG. 2. In accordance with an embodiment, clustering algorithm 324 utilizes an unsupervised machine learning algorithm to cluster the TF-IDF vectors. An example of an unsupervised machine learning algorithm that may be utilized to cluster the TF-IDF vectors includes, but is not limited to a k-means clustering-based algorithm, where the TD-IDF vectors are assigned to clusters based on a distance (e.g., Euclidean distance) from a k number of clusters. It is noted that featurizer 306 and clustering algorithm 314 may utilize different techniques to featurize content of Web pages 302 and cluster Web pages 302, respectively, and the techniques described herein are purely exemplary.

In accordance with an embodiment, the TF-IDF vectors are shareable between a plurality of users. This way, a clusterizer 300 executing on another user's device may cluster Web pages viewed by the other user based on the already-available TF-IDF vectors rather than having to determine them locally.

Referring again to FIG. 2, clusters 212 are provided to keyword determiner 222 and user interface engine 206. Keyword determiner 222 is configured to determine one or more keywords 224 that are representative of each of clusters 212. In accordance with an embodiment in which clusterizer 204 determines TF-IDF vectors, keyword determiner 222 may utilize such vectors to determine the keyword(s). For example, for each cluster determined, clusterizer 204 may provide the TF-IDF vectors associated with the cluster to keyword determiner 222. For each cluster, keyword determiner 222 may determine the top N words (where N is any positive integer) having the highest TD-IDF for that cluster and utilize the top N words as keyword(s) 224 for that cluster. The top-most keyword may be utilized as a title (or label) for the cluster. Keyword(s) 224 are provided to user interface engine 206.

In accordance with an embodiment, clusterizer 204 may be automatically initiated responsive to a user opening up his or her browser history 228 via browser application 218. In accordance with an embodiment, clusterizer 204 may be initiated responsive to receiving explicit user input that causes clusterizer 204 to perform the techniques described herein.

User interface engine 206 is configured to render a user-selectable user interface element (e.g., user-selectable user interface elements 216A-216N) for each of clusters 212 determined by clusterizer 204. User interface engine 206 renders each of user-selectable user interface elements 216A-216N via a user interface 214 (e.g., a browser window) of browser application 218. For each of user-selectable user interface elements 216A-216N, user interface engine 206 also displays a title and/or keywords 224 that are indicative of the subject matter of the associated cluster.

User interface engine 206 is also configured to enable a user to manipulate clusters 212 by interacting with user-selectable user interface elements 216A-216N. For example, a user is enabled to provide user input (e.g., via input device(s) 208) that merges two clusters together. Clusters may be merged by interacting with user-selectable user interface elements 216A-216N.

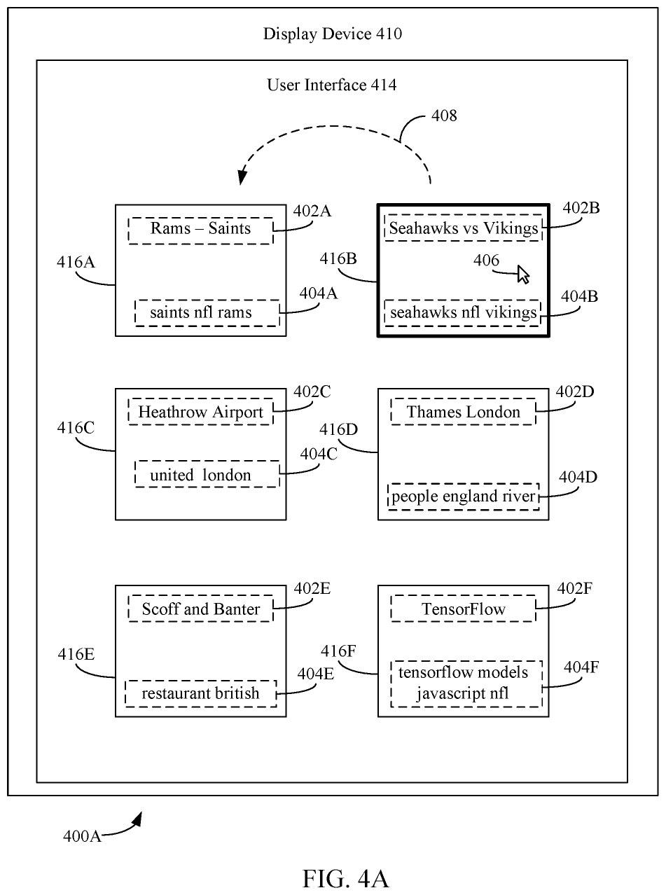

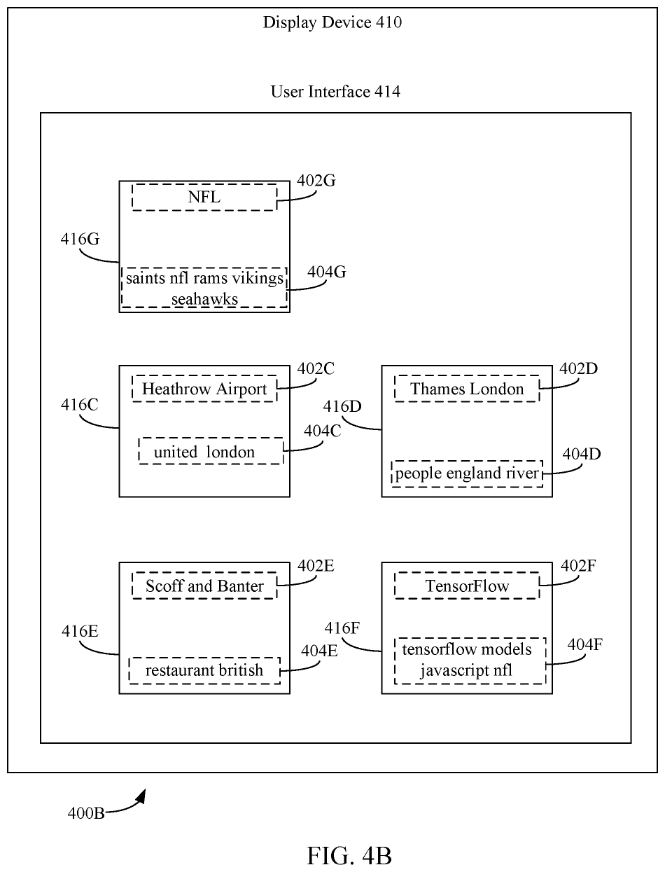

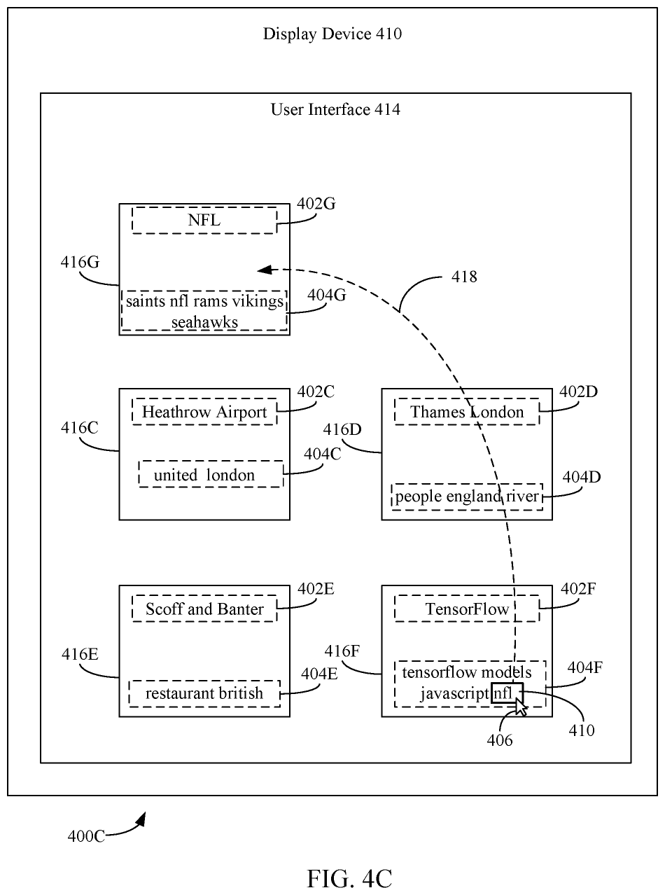

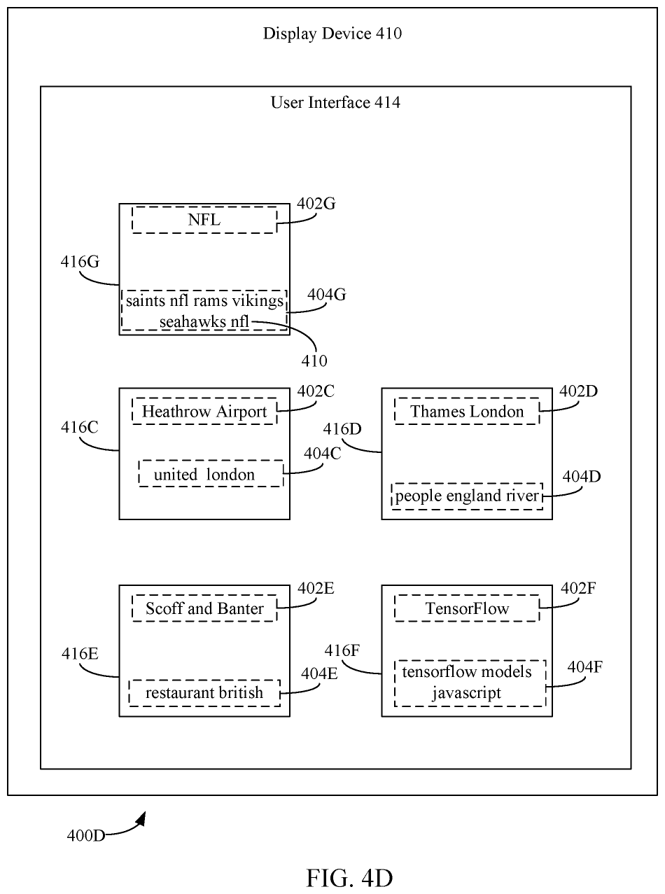

For example, FIGS. 4A-4B depict example graphical user interface (GUI) screens 400A and 400B that enable a user to merge two clusters together in accordance with an example embodiment. The functionality provided by GUI screens 400A and 400B is provided by user interface engine 206, as described above with reference to FIG. 2. Note that GUI screens 400A and 400B are provided for illustrative purposes, and that other arrangements of GUI screens are encompassed in embodiments, as would be apparent to persons skilled in the relevant art(s) from the teachings herein. As shown in FIGS. 4A and 4B, a user interface 414 is displayed via a display device 410. User interface 414 and display device 410 are examples of user interface 214 and display device 210, as described above with reference to FIG. 2. In one example, user interface 414 may be shown to a user responsive to a user requesting to view his/her browser history (e.g., browser history 228, as shown in FIG. 2.) via browser application 218. In another example, user interface 414 may be shown to a user responsive to the user interacting with a user interface element (not shown) that causes a clusterized view of the user's browser history 228 to be shown.

As shown in FIG. 4A, user interface 414 displays user-selectable user interface elements 416A-416F. Each of user-selectable user interface elements 416A-416F corresponds to a cluster of clusters 212 determined by clusterizer 204, as described above with reference to FIG. 2. The corresponding Web pages associated with each cluster may viewed by the user upon a user interacting with user-selectable user interface elements 416A-416F. For instance, to view the Web pages associated with the cluster represented by user-selectable user interface element 402A, a user may activate (e.g., select) user-selectable user interface element 402, and a listing of associated Web pages may be displayed to the user, for example, via another UI screen or window. To view the Web pages associated with the cluster represented by user-selectable user interface element 402B, a user may activate (e.g., select) user-selectable user interface element 402B, and a listing of associated Web pages may be displayed to the user, for example, via another UI screen or window, and so and so forth. A user may activate any of user-selectable user interface elements 402B using input device(s) 208 (as shown in FIG. 2), for example, via a mouse click, touch input, etc.

In accordance with an embodiment, a visualization of when Web pages within the associated cluster were visited by the user is displayed upon a user-interacting with user-selectable user interface elements 416A-416F. For example, the visualization may be a histogram that displays how many times a page was visited at a given day or time. In accordance with another embodiment, the visualization is displayed along with the title and/or keywords of the corresponding user-selectable user interface element.

As also shown in FIG. 4A, user-selectable user interface element 416A displays a title 402A and keywords 404A. User-selectable user interface element 416B displays a title 402B and keywords 404B. User-selectable user interface element 416C displays a title 402C and keywords 404C. User-selectable user interface element 416D displays a title 402D and keywords 404D. User-selectable user interface element 416E displays a title 402E and keywords 404E. User-selectable user interface element 416F displays a title 402F and keywords 404F. Titles 402A-402F and keywords 404A-404F are examples of keywords 224, as described above with reference to FIG. 2.

Any of clusters represented by user-selectable user interface elements 416A-416F may be merged with another cluster represented by another one of user-selectable user interface elements 416A-416F. For instance, suppose the user wants to merge the cluster represented by user-selectable user interface element 416B with the cluster represented by user-selectable user interface element 416A. Using input device(s) 208, the user may select user-selectable user interface element 416B and move user-selectable user interface element 416B to (or over) user-selectable user interface element 416A (e.g., the user may perform a drag-and-drop operation). As shown in FIG. 4A, a user has selected user-selectable user interface element 416B (by moving a cursor 406 over user-selectable user interface element 416 and pressing and/holding a mouse button) and moves (represented by arrow 408) to user-selectable user interface element 416A.

As shown in FIG. 4B, the newly merged clusters are represented by a single user-selectable user-interface element 416G. The merge operation results in the Web pages associated with the clusters represented by each of user-selectable user interface element 416A and user-selectable user interface element 416B to be associated with the new, single cluster represented by user-selectable user interface element 416G. Accordingly, when a user activates user-selectable user interface element 416G, the Web pages associated with the merged cluster (i.e., the Web pages that were associated with both clusters represented by user-selectable user interface elements 402A and 402B) are shown to the user. As also shown FIG. 4B, a union operation may be performed with respect to the keywords that were associated with user-selectable user interface elements 402A and 402B, and the updated list of keywords 404G are displayed in user-selectable user interface element 402G. As further shown FIG. 4B, the title associated with the merged clusters may be updated to more accurately reflect the Web pages associated therewith. For instance, title 402G indicates that the Web pages associated with the cluster are related to the ‘NFL’, rather than being specific to a specific team or grouping of teams.

In another example, each of the keywords displayed via a particular user-selectable user interface element of user-selectable user interface elements 416C-416G may be selected and moved to another one of user-selectable user interface elements 416C-416G. The Web pages associated with the selected keyword are then moved to (i.e., associated with) the cluster represented by the other user-selectable user interface element to which the keyword was moved. The moved keyword is also displayed by the other user-selectable user interface element and removed from the user-selectable user interface element from which the keyword was moved. This can be particularly useful in the event that clusterizer 204 incorrectly clusters Web pages into the wrong cluster.

For example, FIGS. 4C-4D example graphical user interface (GUI) screens 400C and 400D that enable a user to selectively associate certain Web pages of one cluster with another cluster in accordance with an example embodiment. The functionality provided by GUI screens 400C and 400D is provided by user interface engine 206, as described above with reference to FIG. 2. Note that GUI screens 400C and 400D are provided for illustrative purposes, and that other arrangements of GUI screens are encompassed in embodiments, as would be apparent to persons skilled in the relevant art(s) from the teachings herein. As shown in FIGS. 4C and 4D, a user interface 414 is displayed via a display device 410.

Using input device(s) 208, the user may select a keyword displayed via a user-selectable user interface element and move the keyword to another user-selectable user interface element. As shown in FIG. 4C, a user has selected a keyword 410 of user-selectable user interface element 402F (by moving a cursor 406 over keyword 410 and pressing and/holding a mouse button) and moves (represented by arrow 418) to user-selectable user interface element 416G.

As shown in FIG. 4D, keyword 410 is now located in and displayed via user-selectable user interface element 416G. This operation results in the Web pages associated keyword 410 to be moved from the cluster represented by user-selectable user interface element 416F to the cluster represented by user-selectable user interface element 416G. Accordingly, when a user activates user-selectable user interface element 416G, the Web pages associated with keyword 410 are also included in the list of Web pages shown to the user.

Referring again to FIG. 3, after clusters 312 have been determined, clusterizer 300 may utilize a supervised machine learning model to determine which one of clusters 312 new Web pages that a user visits are to be placed. For example, post-cluster classifier 316 is configured to determine a cluster in which to place new Web pages (i.e., pages visited after clustering algorithm 314 has determined clusters 312). Such pages are shown as Web pages 302′ in FIG. 3. Post-cluster classifier 316 is configured to utilize a supervised machine learning model to determine which cluster of clusters 312 to place Web pages 302′. The supervised machine learning model may be trained on clusters 312. For instance, clusters 312 (e.g., the titles thereof) may be used as labels for the supervised machine learning model, and the Web pages in each of clusters 312 may be used as the examples for the supervised machine learning model. Such a technique advantageously takes into account any changes made to clusters 312 by the user, for example, by merging clusters together or moving keywords from one cluster to another cluster.

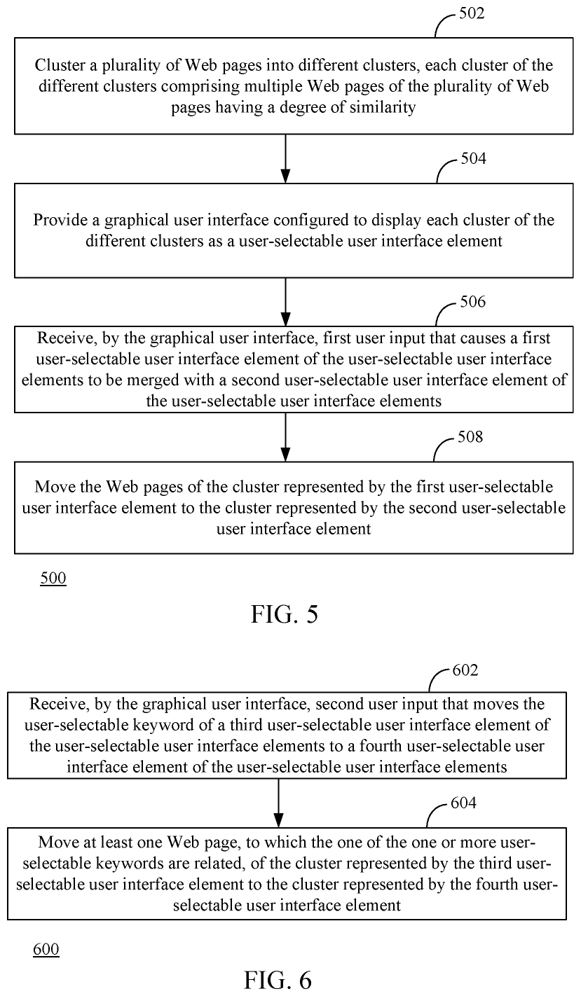

Accordingly, a user's browser history may be managed and organized in many ways. For example, FIG. 5 depicts a flowchart 500 of an example method for managing and organizing a user's browser history in accordance with an example embodiment. The method of flowchart 500 will be described with continued reference to systems 200 and 300 of FIGS. 2 and 3, although the method is not limited to that implementation. Other structural and operational embodiments will be apparent to persons skilled in the relevant art(s) based on the discussion regarding flowchart 500 and systems 200 and 300 of FIGS. 2 and 3.

As shown in FIG. 5, the method of flowchart 500 begins at step 502, in which a plurality of Web pages are clustered into different clusters. Each cluster of the different clusters comprises multiple Web pages of the plurality of Web pages having a degree of similarity. For example, with reference to FIG. 2, clusterizer 204 clusters Web pages 202 into different clusters 212. Each of clusters 212 comprises multiple Web pages having a degree of similarity.

In accordance with one or more embodiments, for each Web page of the plurality of Web pages, the Web page is provided as an input to a supervised machine learning-based algorithm that generates a modified version of the Web page in which a feature is removed from the Web page, and the modified versions of the Web pages are provided as an input to an unsupervised machine learning-based algorithm that clusters the modified versions of the Web pages into the different clusters. For example, with reference to FIG. 3, Web pages 302 are provided as an input to content filter 304, which utilizes a supervised machine learning-based algorithm that generates a modified version of the Web page in which a feature is removed from the Web page. The modified versions (or filtered versions) of Web pages 302 are provided to featurizer 306, which featurizes each of filtered Web pages 302 stored in data store 310. Featurizer 306 may output TD-IDF vectors representative of the content of each of the filtered Web pages 402. The TD-IDF vectors are provided to clustering algorithm 314. Clustering algorithm 314 utilizes an unsupervised machine learning-based algorithm to cluster Web pages 302 into different clusters 312.

In accordance with one or more embodiments, the feature removed from Web pages 304 comprises one or more of boilerplate language, advertisements, legal disclaimers, or script tags.

In accordance with one or more embodiments, content from the plurality of Web pages with which a user has interacted is determined. The unsupervised machine learning-based algorithm clusters the modified versions of the Web pages into the different clusters based on the determined content. For example, with reference to FIG. 3, monitor 320 monitors user interactions with respect to Web pages 302 and determines the content that was interacted with. Featurizer 306 may weight certain terms of TD-IDF vectors based on the content that was interacted with. Clustering algorithm 314 may cluster the filtered Web pages 302 into the different clusters based on the weighted TD-IDF vectors.

At step 504, a graphical user interface configured to display each cluster of the different clusters as a user-selectable user interface element is provided. For example, with reference to FIG. 2, user interface engine 206 provides user interface 214 that is configured to display each cluster of clusters 212 as user-selectable user interface element (e.g., user-selectable user interface elements 216A-216N).

At step 506, first user input is received by the graphical user interface that causes a first user-selectable user interface element of the user-selectable user interface elements to be merged with a second user-selectable user interface element of the user-selectable user interface elements. For example, with reference to FIG. 2, user interface 214 receives first user input via input device(s) 208 and user interface engine 206 that causes a first user-selectable user interface element of the user-selectable user interface elements 216A-216N to be merged with a second user-selectable user interface element of the user-selectable user interface elements 216A-216N. Referring to FIGS. 4A-4B, user interface 414 receives user input that selects user-selectable user interface element 416B and merges user-selectable user interface element 416B with user-selectable user interface element 416A to generate a new user-selectable user interface element (e.g., user-selectable user interface element 416G.

At step 508, the Web pages of the cluster represented by the first user-selectable user interface element are moved to the cluster represented by the second user-selectable user interface element. For example, with reference to FIGS. 4A-4B, the Web pages associated with the cluster represented by first user-selectable user interface element 416B are moved to the cluster represented by second user-selectable user interface element 416A. The merged cluster is represented as user-selectable user interface element 416G, as shown in FIG. 4B.

In accordance with one or more embodiments, for each new Web page received, the new Web page is provided as an input to a supervised machine learning-based algorithm that is configured to determine a cluster of the different clusters to which the new Web page belongs. The supervised machine learning-based algorithm is trained on the different clusters. For example, with reference to FIG. 3, new Web pages 302′ viewed by the user after clustering algorithm 314 determines clusters 312, are provided as an input to post-cluster classifier 316. Post-cluster classifier 316 is configured to utilize a supervised machine learning-based algorithm that is configured to determine a cluster of clusters 312 to which new Web pages 302′ belong. The supervised machine learning-based algorithm is trained on clusters 312.

In accordance with one or more embodiments, each user-selectable user interface element comprises a user-selectable keyword related to the Web pages of a cluster of the different clusters represented thereby. For example, with reference to FIG. 2, keyword determiner 222 is configured to determine one or more keywords 224 that are representative of each of clusters 212. In accordance with an embodiment in which clusterizer 204 determines TF-IDF vectors, keyword determiner 222 may utilize such vectors to determine the keyword(s). For example, for each cluster determined, clusterizer 204 may provide the TF-IDF vectors associated with the cluster to keyword determiner 222. For each cluster, keyword determiner 222 may determine the top N words (where N is any positive integer) having the highest. User interface engine 206 causes keywords 224 to be rendered for each of user-interactive interface elements 216A-216N via user interface 214.

FIG. 6 depicts a flowchart 600 of an example method for selectively moving Web pages from one cluster to another cluster in accordance with an example embodiment. The method of flowchart 600 will be described with continued reference to system 200 of FIG. 2, although the method is not limited to that implementation. Other structural and operational embodiments will be apparent to persons skilled in the relevant art(s) based on the discussion regarding flowchart 600 and system 200 of FIG. 2.

As shown in FIG. 6, the method of flowchart 600 begins at step 602, at which second user input is received by the graphical user interface that moves the user-selectable keyword of a third-user selectable user interface element of the user-selectable user interface elements to a fourth user-selectable user interface element of the user-selectable user interface elements. For example, with reference to FIG. 2, user interface 214 receives second user input via input device(s) 208 and user interface engine 206 that moves the user-selectable keyword of a third-user selectable user interface element of the user-selectable user interface elements 216A-216N to a fourth user-selectable user interface element of the user-selectable user interface elements 216A-216N. With reference to FIGS. 4C-4D, a user selects keyword 410 and moves keyword 410 to user-interactive user interface element 416G.

At step 604, at least one Web page, to which the one of the one or more user-selectable keywords are related, of the cluster represented by the third user-selectable user interface element is moved to the cluster represented by the fourth user-selectable user interface element. For example, with reference to FIGS. 4C-4D, the Web pages associated with keyword 410 of the cluster represented by user-selectable user interface element 416F are moved to the cluster represented by user-selectable user interface element 416G.

### III. Example Mobile and Stationary Device Embodiments

The systems and methods described above, including the graphical user interface for managing and configuring data items described in reference to FIGS. 1-6, may be implemented in hardware, or hardware combined with one or both of software and/or firmware. For example, clusterizer 104, user interface engine 106, user interface 114, user-selectable user-interface elements 116A-116N, computing device 226, browser application 218, clusterizer 204, monitor 220, user interface engine 206, keyword determiner 222, browser history 228, user interface 214, user-selectable interface elements 216A-216B, clusterizer 300, content filter 304, data store 310, featurizer 306, monitor 320, clustering algorithm 314, post-cluster classifier 316, user interface 414, and user-selectable user interface elements 404A-404G, and/or each of the components described therein, and flowchart 500 and/or 600 may be each implemented as computer program code/instructions configured to be executed in one or more processors and stored in a computer readable storage medium. Alternatively, clusterizer 104, user interface engine 106, user interface 114, user-selectable user-interface elements 116A-116N, computing device 226, browser application 218, clusterizer 204, monitor 220, user interface engine 206, keyword determiner 222, browser history 228, user interface 214, user-selectable interface elements 216A-216B, clusterizer 300, content filter 304, data store 310, featurizer 306, monitor 320, clustering algorithm 314, post-cluster classifier 316, user interface 414, and user-selectable user interface elements 404A-404G, and/or each of the components described therein, and flowchart 500 and/or 600 may be implemented as hardware logic/electrical circuitry. In an embodiment, clusterizer 104, user interface engine 106, user interface 114, user-selectable user-interface elements 116A-116N, computing device 226, browser application 218, clusterizer 204, monitor 220, user interface engine 206, keyword determiner 222, browser history 228, user interface 214, user-selectable interface elements 216A-216B, clusterizer 300, content filter 304, data store 310, featurizer 306, monitor 320, clustering algorithm 314, post-cluster classifier 316, user interface 414, and user-selectable user interface elements 404A-404G, and/or each of the components described therein, and flowchart 500 and/or 600 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 7 shows a block diagram of an exemplary mobile device 700 including a variety of optional hardware and software components, shown generally as components 702. Any number and combination of the features/elements of clusterizer 104, user interface engine 106, user interface 114, user-selectable user-interface elements 116A-116N, computing device 226, browser application 218, clusterizer 204, monitor 220, user interface engine 206, keyword determiner 222, browser history 228, user interface 214, user-selectable interface elements 216A-216B, clusterizer 300, content filter 304, data store 310, featurizer 306, monitor 320, clustering algorithm 314, post-cluster classifier 316, user interface 414, and user-selectable user interface elements 404A-404G, and/or each of the components described therein, and flowchart 500 and/or 600 may be implemented as components 702 included in a mobile device embodiment, as well as additional and/or alternative features/elements, as would be known to persons skilled in the relevant art(s). It is noted that any of components 702 can communicate with any other of components 702, although not all connections are shown, for ease of illustration. Mobile device 700 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 704, such as a cellular or satellite network, or with a local area or wide area network.

The illustrated mobile device 700 can include a controller or processor referred to as processor circuit 710 for performing such tasks as signal coding, image processing, data processing, input/output processing, power control, and/or other functions. Processor circuit 710 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 710 may execute program code stored in a computer readable medium, such as program code of one or more applications 714, operating system 712, any program code stored in memory 720, etc. Operating system 712 can control the allocation and usage of the components 702 and support for one or more application programs 714 (a.k.a. applications, “apps”, etc.). Application programs 714 can include common mobile computing applications (e.g., email applications, calendars, contact managers, web browsers, messaging applications) and any other computing applications (e.g., word processing applications, mapping applications, media player applications).

As illustrated, mobile device 700 can include memory 720. Memory 720 can include non-removable memory 722 and/or removable memory 724. The non-removable memory 722 can include RAM, ROM, flash memory, a hard disk, or other well-known memory storage technologies. The removable memory 724 can include flash memory or a Subscriber Identity Module (SIM) card, which is well known in GSM communication systems, or other well-known memory storage technologies, such as “smart cards.” The memory 720 can be used for storing data and/or code for running operating system 712 and applications 714. Example data can include web pages, text, images, sound files, video data, or other data sets to be sent to and/or received from one or more network servers or other devices via one or more wired or wireless networks. Memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 720. These programs include operating system 712, one or more application programs 714, and other program modules and program data. Examples of such application programs or program modules may include, for example, computer program logic (e.g., computer program code or instructions) for implementing the systems described above, including the device compliance management embodiments described in reference to FIGS. 1-6.

Mobile device 700 can support one or more input devices 730, such as a touch screen 732, microphone 734, camera 736, physical keyboard 738 and/or trackball 740 and one or more output devices 750, such as a speaker 752 and a display 754.

Other possible output devices (not shown) can include piezoelectric or other haptic output devices. Some devices can serve more than one input/output function. For example, touch screen 732 and display 754 can be combined in a single input/output device. The input devices 730 can include a Natural User Interface (NUI).

Wireless modem(s) 760 can be coupled to antenna(s) (not shown) and can support two-way communications between processor circuit 710 and external devices, as is well understood in the art. The modem(s) 760 are shown generically and can include a cellular modem 766 for communicating with the mobile communication network 704 and/or other radio-based modems (e.g., Bluetooth 764 and/or Wi-Fi 762). Cellular modem 766 may be configured to enable phone calls (and optionally transmit data) according to any suitable communication standard or technology, such as GSM, 3G, 4G, 5G, etc. At least one of the wireless modem(s) 760 is typically configured for communication with one or more cellular networks, such as a GSM network for data and voice communications within a single cellular network, between cellular networks, or between the mobile device and a public switched telephone network (PSTN).

Mobile device 700 can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components 702 are not required or all-inclusive, as any components can be not present and other components can be additionally present as would be recognized by one skilled in the art.

Furthermore, FIG. 8 depicts an exemplary implementation of a computing device 800 in which embodiments may be implemented, including clusterizer 104, user interface engine 106, user interface 114, user-selectable user-interface elements 116A-116N, computing device 226, browser application 218, clusterizer 204, monitor 220, user interface engine 206, keyword determiner 222, browser history 228, user interface 214, user-selectable interface elements 216A-216B, clusterizer 300, content filter 304, data store 310, featurizer 306, monitor 320, clustering algorithm 314, post-cluster classifier 316, user interface 414, and user-selectable user interface elements 404A-404G, and/or each of the components described therein, and flowchart 500 and/or 600. The description of computing device 800 provided herein is provided for purposes of illustration, and is not intended to be limiting. Embodiments may be implemented in further types of computer systems, as would be known to persons skilled in the relevant art(s).

As shown in FIG. 8, computing device 800 includes one or more processors, referred to as processor circuit 802, a system memory 804, and a bus 806 that couples various system components including system memory 804 to processor circuit 802. Processor circuit 802 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 802 may execute program code stored in a computer readable medium, such as program code of operating system 830, application programs 832, other programs 834, etc. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computing device 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 830, one or more application programs 832, other programs 834, and program data 836. Application programs 832 or other programs 834 may include, for example, computer program logic (e.g., computer program code or instructions) for implementing the systems described above, including the graphical user interface for managing and configuring data items described in reference to FIGS. 1-6.

A user may enter commands and information into the computing device 800 through input devices such as keyboard 838 and pointing device 840. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 802 through a serial port interface 842 that is coupled to bus 806, but may be connected by other interfaces, such as a parallel port, game port, or a universal serial bus (USB).

A display screen 844 is also connected to bus 806 via an interface, such as a video adapter 846. Display screen 844 may be external to, or incorporated in computing device 800. Display screen 844 may display information, as well as being a user interface for receiving user commands and/or other information (e.g., by touch, finger gestures, virtual keyboard, etc.). In addition to display screen 844, computing device 800 may include other peripheral output devices (not shown) such as speakers and printers.

Computing device 800 is connected to a network 848 (e.g., the Internet) through an adaptor or network interface 850, a modem 852, or other means for establishing communications over the network. Modem 852, which may be internal or external, may be connected to bus 806 via serial port interface 842, as shown in FIG. 8, or may be connected to bus 806 using another interface type, including a parallel interface.

As used herein, the terms “computer program medium,” “computer-readable medium,” and “computer-readable storage medium” are used to generally refer to physical hardware media such as the hard disk associated with hard disk drive 814, removable magnetic disk 818, removable optical disk 822, other physical hardware media such as RAMs, ROMs, flash memory cards, digital video disks, zip disks, MEMs, nanotechnology-based storage devices, and further types of physical/tangible hardware storage media (including system memory 804 of FIG. 8). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 832 and other programs 834) may be stored on the hard disk, magnetic disk, optical disk, ROM, RAM, or other hardware storage medium. Such computer programs may also be received via network interface 850, serial port interface 852, or any other interface type. Such computer programs, when executed or loaded by an application, enable computing device 800 to implement features of embodiments discussed herein. Accordingly, such computer programs represent controllers of the computing device 800.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Exemplary Embodiments

A method is described herein. The method includes: clustering a plurality of Web pages associated with the browser history into different clusters, each cluster of the different clusters comprising multiple Web pages of the plurality of Web pages having a degree of similarity; providing a graphical user interface configured to display each cluster of the different clusters as a user-selectable user interface element; receiving, by the graphical user interface, first user input that causes a first user-selectable user interface element of the user-selectable user interface elements to be merged with a second user-selectable user interface element of the user-selectable user interface elements; and moving the Web pages of the cluster represented by the first user-selectable user interface element to the cluster represented by the second user-selectable user interface element.

In an embodiment of the method, each user-selectable user interface element comprises a user-selectable keyword related to the Web pages of a cluster of the different clusters represented thereby.

In an embodiment of the method, the method further comprises: receiving, by the graphical user interface, second user input that moves the user-selectable keyword of a third user-selectable user interface element of the user-selectable user interface elements to a fourth user-selectable user interface element of the user-selectable user interface elements; and moving at least one Web page, to which the one of the one or more user-selectable keywords are related, of the cluster represented by the third user-selectable user interface element to the cluster represented by the fourth user-selectable user interface element.

In an embodiment of the method, clustering the plurality of Web pages into different clusters comprises: for each Web page of the plurality of Web pages, providing the Web page as an input to a supervised machine learning-based algorithm that generates a modified version of the Web page in which a feature is removed from the Web page; and providing the modified versions of the Web pages as an input to an unsupervised machine learning-based algorithm that clusters the modified versions of the Web pages into the different clusters.

In an embodiment of the method, the feature comprises at least one of: boilerplate language; advertisements; legal disclaimers; or script tags.

In an embodiment of the method, the method further comprises: determining content from the plurality of Web pages with which a user has interacted, wherein the unsupervised machine learning-based algorithm clusters the modified versions of the Web pages into the different clusters based on the determined content.

In an embodiment of the method, the method further comprises: for each new Web page received, providing the new Web page as an input to a supervised machine learning-based algorithm that is configured to determine a cluster of the different clusters to which the new Web page belongs, the supervised machine learning-based algorithm being trained on the different clusters.

A computing device is also described herein. The computing device includes at least one processor circuit and at least one memory that stores program code configured to be executed by the at least one processor circuit, the program code comprising: a clusterizer configured to cluster a set of data items into different clusters, each cluster of the different clusters comprising multiple data items of the set of data items having a degree of similarity; and a user interface engine configured to: provide a graphical user interface configured to display each cluster of the different clusters as a user-selectable user interface element; receive first user input that causes a first user-selectable user interface element of the user-selectable user interface elements to be merged with a second user-selectable user interface element of the user-selectable user interface elements; and move the data items of the cluster represented by the first user-selectable user interface element to the cluster represented by the second user-selectable user interface element.

In an embodiment of the computing device, each user-selectable user interface element comprises a user-selectable keyword related to the data items of a cluster of the different clusters represented thereby.

In an embodiment of the computing device, the user interface engine is further configured to: receive second user input that moves the user-selectable keyword of a third user-selectable user interface element of the user-selectable user interface elements to a fourth user-selectable user interface element of the user-selectable user interface elements; and move at least one data item, to which the one of the one or more user-selectable keywords are related, of the cluster represented by the third user-selectable user interface element to the cluster represented by the fourth user-selectable user interface element.

In an embodiment of the computing device, the set of data items comprises a plurality of Web pages collected by a browser application during a Web browsing session.

In an embodiment of the computing device, the clusterizer is further configured to: for each data item of the set of data items, provide the data item as an input to a supervised machine learning-based algorithm that generates a modified version of the data item in which a feature is removed from the data item; and provide the modified versions of the data items as an input to an unsupervised machine learning-based algorithm that clusters the modified versions of the data items into the different clusters.

In an embodiment of the computing device, the feature comprises at least one of: boilerplate language; advertisements; legal disclaimers; or script tags.

In an embodiment of the computing device, the program code further comprises: a monitor configured to determine content from the plurality of data items with which a user has interacted, wherein the unsupervised machine learning-based algorithm clusters the modified versions of the data items into the different clusters based on the determined content.

In an embodiment of the computing device, the clusterizer is further configured to: for each new data item received, provide the new data item as an input to a supervised machine learning-based algorithm that is configured to determine a cluster of the different clusters to which the new data item belongs, the supervised machine learning-based algorithm being trained on the different clusters.

A computer-readable storage medium having program instructions recorded thereon that, when executed by at least one processor, perform a method is further described herein. The method includes clustering a set of data items into different clusters, each cluster of the different clusters comprising multiple data items of the set of data items having a degree of similarity; providing a graphical user interface configured to display each cluster of the different clusters as a user-selectable user interface element; receiving, by the graphical user interface, first user input that causes a first user-selectable user interface element of the user-selectable user interface elements to be merged with a second user-selectable user interface element of the user-selectable user interface elements; and moving the data items of the cluster represented by the first user-selectable user interface element to the cluster represented by the second user-selectable user interface element.

In an embodiment of the computer-readable storage medium, each user-selectable user interface element comprises a user-selectable keyword related to the data items of a cluster of the different clusters represented thereby.

In an embodiment of the computer-readable storage medium, the method further comprising: receiving, by the graphical user interface, second user input that moves the user-selectable keyword of a third user-selectable user interface element of the user-selectable user interface elements to a fourth user-selectable user interface element of the user-selectable user interface elements; and moving at least one data item, to which the one of the one or more user-selectable keywords are related, of the cluster represented by the third user-selectable user interface element to the cluster represented by the fourth user-selectable user interface element.

In an embodiment of the computer-readable storage medium, the set of data items comprises a plurality of Web pages collected by a browser application during a Web browsing session.

The computer-readable storage medium of claim 16, wherein clustering the plurality of Web pages into different clusters comprises: for each Web page of the plurality of Web pages, providing the Web page as an input to a supervised machine learning-based algorithm that generates a modified version of the Web page in which a feature is removed from the Web page; and providing the modified versions of the Web page as an input to an unsupervised machine learning-based algorithm that clusters the modified versions of the Web page into the different clusters.

### V. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

1. A method, comprising:
associating weights, respectively, with each Web page of a plurality of Web pages associated with a browser history, each Web page of the plurality of Web pages receiving at least one of the weights based on at least one of a frequency of user interaction with the Web page or a level of interaction with text of the Web page;
clustering the plurality of Web pages into different clusters in accordance with the weights, each cluster of the different clusters comprising multiple Web pages of the plurality of Web pages having a degree of similarity;
providing a graphical user interface configured to display each cluster of the different clusters as a user-selectable user interface element, at least one of the user-selectable user interface elements comprising a plurality of user-selectable keywords, each related to a respective subset of Web pages of a cluster of the different clusters represented thereby;
receiving, by the graphical user interface, first user input that moves a first user-selectable keyword of the plurality of user-selectable keywords to a second user-selectable user interface element of the user-selectable user interface elements; and
moving a subset of Web pages of the cluster represented by the first user-selectable user interface element and that are related to the first user-selectable keyword to the cluster represented by the second user-selectable user interface element.

2-3. (canceled)

4. The method of claim 1, wherein clustering the plurality of Web pages into different clusters comprises:
for each Web page of the plurality of Web pages, providing the Web page as an input to a supervised machine learning-based algorithm that generates a modified version of the Web page in which a feature is removed from the Web page; and
providing the modified versions of the Web page as an input to an unsupervised machine learning-based algorithm that clusters the modified versions of the Web page into the different clusters.

5. The method of claim 4, wherein the feature comprises at least one of:
boilerplate language;
advertisements;
legal disclaimers; or
script tags.

6. The method of claim 4, further comprising
determining content from the plurality of Web pages with which a user has interacted, wherein the unsupervised machine learning-based algorithm clusters the modified versions of the Web pages into the different clusters based on the determined content.

7. The method of claim 1, further comprising:
for each new Web page received, providing the new Web page as an input to a supervised machine learning-based algorithm that is configured to determine a cluster of the different clusters to which the new Web page belongs, the supervised machine learning-based algorithm being trained on the different clusters.

8. A computing device, comprising:
at least one processor circuit; and
at least one memory that stores program code configured to be executed by the at least one processor circuit, the program code comprising:
a clusterizer configured to:
associate weights, respectively, with each data item of a plurality of data items, each data item of the plurality of data item receiving at least one of the weights based on at least one of a frequency of user interaction with the data item or a level of interaction with text of the data item; and
cluster the set of data items into different clusters in accordance with the weights, each cluster of the different clusters comprising multiple data items of the set of data items having a degree of similarity; and
a user interface engine configured to:
provide a graphical user interface configured to display each cluster of the different clusters as a user-selectable user interface element, at least one of the user-selectable user interface elements comprising a plurality of user-selectable keywords, each related to a respective subset of data items of a cluster of the different clusters represented thereby;
receive first user input that moves a first user-selectable keyword of the plurality of user-selectable keywords to a second user-selectable user interface element of the user-selectable user interface elements; and
move a subset of data items of the cluster represented by the first user-selectable user interface element and that are related to the first user-selectable keyword to the cluster represented by the second user-selectable user interface element.

9. The computing device of claim 8, wherein the set of data items comprises a plurality of Web pages collected by a browser application during a Web browsing session.

10-11. (canceled)

12. The computing device of claim 8, wherein the clusterizer is further configured to:
for each data item of the set of data items, provide the data item as an input to a supervised machine learning-based algorithm that generates a modified version of the data item in which a feature is removed from the data item; and
provide the modified versions of the data items as an input to an unsupervised machine learning-based algorithm that clusters the modified versions of the data items into the different clusters.

13. The computing device of claim 12, wherein the feature comprises at least one of:
boilerplate language;
advertisements;
legal disclaimers; or
script tags.

14. The computing device of claim 12, wherein the program code further comprises:
a monitor configured to determine content from the plurality of data items with which a user has interacted, wherein the unsupervised machine learning-based algorithm clusters the modified versions of the data items into the different clusters based on the determined content.

15. The computing device of claim 8, wherein the clusterizer is further configured to:
for each new data item received, provide the new data item as an input to a supervised machine learning-based algorithm that is configured to determine a cluster of the different clusters to which the new data item belongs, the supervised machine learning-based algorithm being trained on the different clusters.

16. A computer-readable storage medium having program instructions recorded thereon that, when executed by at least one processor of a computing device, perform a method, the method comprising:
associating weights, respectively, with each data item of a plurality of data items, each data item of the plurality of data items receiving at least one of the weights based on at least one of a frequency of user interaction with the data item or a level of interaction with text of the data item:
clustering the set of data items into different clusters in accordance with the weights, each cluster of the different clusters comprising multiple data items of the set of data items having a degree of similarity;
providing a graphical user interface configured to display each cluster of the different clusters as a user-selectable user interface element, at least one of the user-selectable user interface elements comprising a plurality of user-selectable keywords, each related to a respective subset of data items of a cluster of the different clusters represented thereby;
receiving, by the graphical user interface, first user input that moves a first user-selectable keyword of the plurality of user-selectable keywords to a second user-selectable user interface element of the user-selectable user interface elements; and
moving a subset of data items of the cluster represented by the first user-selectable user interface element and that are related to the first user-selectable keyword to the cluster represented by the second user-selectable user interface element.

17. The computer-readable storage medium of claim 16, wherein the set of data items comprises a plurality of Web pages collected by a browser application during a Web browsing session.

18-19. (canceled)

20. The computer-readable storage medium of claim 16, wherein clustering the plurality of data items into different clusters comprises:
for each data item of the plurality of data items, providing the data item as an input to a supervised machine learning-based algorithm that generates a modified version of the data item in which a feature is removed from the data item; and
providing the modified versions of the data item as an input to an unsupervised machine learning-based algorithm that clusters the modified versions of the data item into the different clusters.

21. The computer-readable storage medium of claim 20, wherein clustering the plurality of data items into different clusters comprises:
for each data item of the set of data items, providing the data item as an input to a supervised machine learning-based algorithm that generates a modified version of the data item in which a feature is removed from the data item; and
providing the modified versions of the data items as an input to an unsupervised machine learning-based algorithm that clusters the modified versions of the data items into the different clusters.

22. The computer-readable storage medium of claim 21, wherein the feature comprises at least one of:
boilerplate language;
advertisements;
legal disclaimers; or
script tags.

23. The computer-readable storage medium of claim 21, the method further comprising:
determining content from the plurality of data items with which a user has interacted, wherein the unsupervised machine learning-based algorithm clusters the modified versions of the data items into the different clusters based on the determined content.

24. The computer-readable storage medium of claim 16, wherein said clustering comprises:
for each new data item received, providing the new data item as an input to a supervised machine learning-based algorithm that is configured to determine a cluster of the different clusters to which the new data item belongs, the supervised machine learning-based algorithm being trained on the different clusters.

25. The method of claim 1, wherein the plurality of user-selectable keywords is determined based on term frequencies of terms included in Web pages of the cluster represented by the at least one of the user-selectable user interface elements.

26. The computing device of claim 8, wherein the plurality of user-selectable keywords is determined based on term frequencies of terms included in data items of the cluster represented by the at least one of the user-selectable user interface elements.
